(19) United States
(12) Patent Application Publication
(10) Pub. No.: US 2009/0165312 A1
(43) Pub. Date: Jul. 2, 2009

(54) Hand-held power tool

(76) Inventors: Gunter Haas, Kaufering (DE); Konstantin Baxivanelis, Kaufering (DE); Markus Looser, Landsberg (DE)

Correspondence Address: ABELMAN, FRAYNE & SCHWAB, 666 THIRD AVENUE, 10TH FLOOR, NEW YORK, NY, 10017, US

(21) Appl. No.: 12/313,552

(22) Filed: Nov. 21, 2008

(30) Foreign Application Priority Data
Nov. 22, 2007 (DE) 10 2007 056 381.9

(51) Int. Cl. B27B 9/04

(52) U.S. Cl. 30/390

(57) ABSTRACT

A hand-held power tool includes a motor (13) for driving the cutting or grinding tool (11), a fan (15) for cooling the motor (13), a protective cover device (30) for at least partially covering the cutting or grinding tool (11), and a guide shoe (20) for placing the hand-held power tool on a to-be-treated workpiece and having a tool opening (26) for the cutting or grinding tool (11) and at least one air guide channel (21) having at least one inlet opening (22) for connecting the air guide channel (21) with the fan (15) and at least one blow-out opening (23) arranged sidewise of the tool opening (26).

### BACKGROUND OF THE INVENTION

1. Field of the Invention

The present invention relates to a hand-held power tool such as a grinding or cutting-off power tool and having a protective cover device for at least partially covering a grinding or cutting tool.

2. Description of the Prior Art

During operation of such hand-held power tool, a substantial quantity of dust is produced. For its collection, there are provided protective cover devices connectable with dust suction devices that should remove the dust.

German Publication DE 35 25 091 A1 discloses a hand-held power tool that is formed as a power saw the disc-shaped tool of which, e.g., a circular saw blade is driven by a drive motor. A protective cover member, which is formed as a protective hood, partially covers the disc-shaped tool. The protective cover member is provided with a connection or suction union to which a suction device can be connected for aspirating dust produced during the operation of the power tool.

The drawback o the protective cover means of the above-described power tool consists in that during the operation of the power tool, dust particles can penetrate through openings in the protective cover member, despite an active dust suction, outside and form a dust layer on the treated workpiece.

Accordingly, an object of the present invention is to provide a hand-held power tool in which the drawbacks of the known hand-held power tools are eliminated, and a most possible complete suction of the dust particles becomes possible.

### SUMMARY OF THE INVENTION

This and other objects of the present invention, which will become apparent hereinafter, are achieved by providing a hand-held power tool of the type described in German Publication DE 35 25 092 A1 and in which the guide shoe has an opening for the cutting or grinding tool and at least one air guide channel having at least one inlet opening for connecting the air guide channel with the fan and at least one blow-out opening arrange sidewise of the tool opening.

With the at least one blow-out opening, during the operation of the power tool, the air, which is expelled through the blow-out openings, produces an air haze that covers the cutting or grinding tool 11 outwardly at least in the working region of the cutting or grinding tool. The air haze 25 prevents to a most possible extent exit of dust and/or material particles from the protective cover device. The working region remains free from dust and material particles, insuring always a very good view of the working region for the power tool user.

Advantageously, there are provided two blow-out openings arranged on opposite sides of the tool opening. Thereby, an air haze is formed on both sides of the cutting or grinding tool.

It is advantageous when the at least one opening is formed as an elongate slot-shaped opening. This permits to produce a high-velocity air flow over a certain length of the working region.

According to a constructively simple solution, the air guide channel is formed directly in the guide shoe. Thereby, the formation of an air guide channel on an outer surface of the guide shoe can be avoided.

Advantageously, the protective cover device has at least one tubular connection union that projects from the cover member for connection with a suction device. Thereby, the air haze is displaced toward the connection union by the suction air flow produced by the suction device, so that a relatively continuous air haze is achieved.

It is advantageous, e.g., when the at least one tubular connection union is located diametrically opposite the at least one blow-out opening. This permit to produce an optimal air haze during the operation of the inventive hand-held power tool.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partially cross-sectional side view of a hand-held power tool according to the present invention; and

FIG. 2 a plan view of a guide shoe of the hand-held power tool shown in FIG. 1 with indicated saw blade and fan wheel.

### DETAILED DESCRIPTION OF THE PREFERRED EMBODIMENT

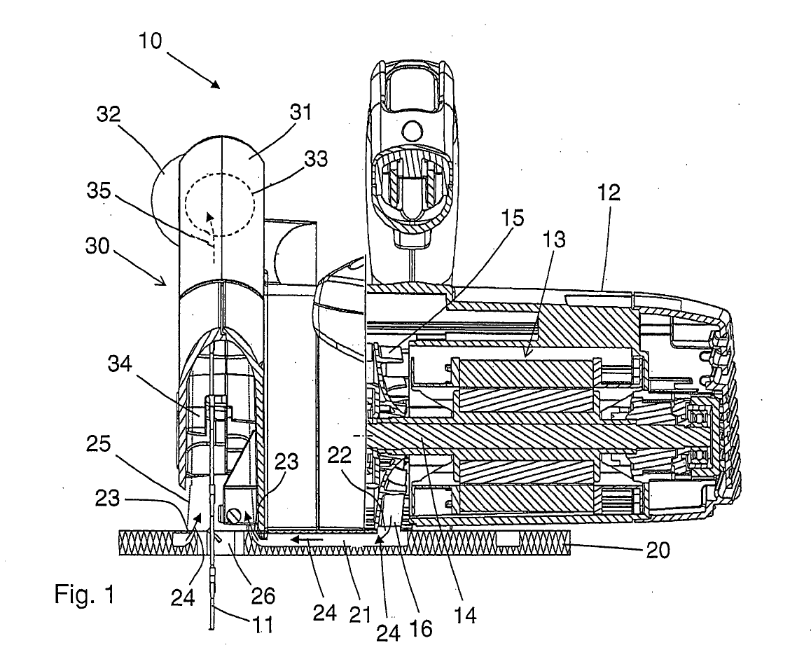

A hand-held power tool 10 according to the present invention, which is formed as a cutting-off power tool, e.g., as a hand-held circular saw and is shown in FIG. 1, includes a disc-shaped cutting tool 11 that is formed as a circular saw blade or a grinding tool for cutting-off objects, and a motor 13 for driving the cutting tool 11 and which is located in the power tool housing 12. The hand-held power tool 10 further has a guide shoe 20 that is formed as a base plate with which the hand-held power tool 10 is supported on a to-be-treated workpiece. On a shaft 14 that projects from the motor 13, a fan 15 is mounted.

The fan 15 provides for flow of air for cooling the hand-held power tool. The shaft 14 further serves for driving the disc-shaped cutting or grinding tool 11.

For protecting the power tool operator from removable material particles and dust particles which are accelerated in a radial direction of the cutting or grinding tool 11 during the operation of the power tool 10, the hand-held power tool 10 has a protective cover device generally designated with a reference numeral 30. The protective cover device 30 has, to this end, a hood-shaped cover member 31 that circumferentially surrounds the cutting or grinding tool 11 in the radial direction at least partially. The cover member 31 is secured on the cutting or grinding tool-side of the power tool housing 12 with connection region of the protective cover device 30.

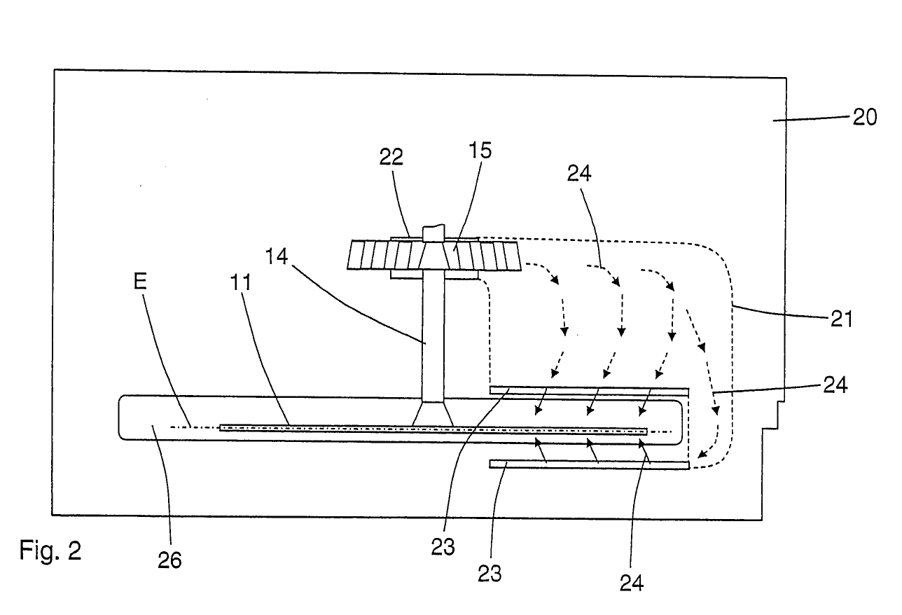

The protective cover device 30 further has a tubular connection union 32 for a suction device (not shown in FIGS. 1 and 2) such as, e.g., an industrial vacuum cleaner. An opening 33 connects the cover member 31 with the connection union 32 so that with a suction device connected to the connection union, an air flow (shown by arrow 35) is produced from the inner space 34 of the cover member 31 upon actuation of the suction device.

An inlet opening 22 in the guide shoe 20 and a housing opening 16 connect an air guide channel 21, which is formed in the guide shoe 20, with the fan 15, whereby the air delivered from the fan 15 is blown into the air guide channel 21. The air flows through the air guide channel 21 (see arrows 24 in FIGS. 1 and 2) and is expelled through at least two slot-shaped blow-out openings 23. The openings 23 are arranged sidewise of the cutting or grinding tool 11 or sidewise of a tool opening 26 for the cutting and grinding tool 11 in the guide shoe 20, so that the blow-out openings 23 extend essentially parallel to a plane E defined by the cutting or grinding tool 11. During the operation of the power tool 10, the air, which is expelled through the blow-out openings 23, produces an air haze 25 that covers the cutting or grinding tool 11 outwardly at least in the working region of the cutting or grinding tool. The air haze 25 prevents to a most possible extent exit of dust and/or material particles from the protective cover device 30. The air haze 25 is displaced toward the connection union 32 by a suction air flow produced by the suction device, whereby a relatively continuous air haze is produced. The connection union 32 is arranged substantially diametrically opposite the blow-out openings 23.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising a cutting or grinding tool (11); a motor (13) for driving the cutting or grinding tool (11); a fan (15) for cooling the motor (13); a protective cover device (30) for at least partially covering the cutting or grinding tool (11) and having at least one hood-shaped cover member (31); and a guide shoe (20) for placing the hand-held power tool on a to-be-treated workpiece, the guide shoe (20) having a tool opening (26) for the cutting or grinding tool (11) and at least one air guide channel (21) having at least one inlet opening (22) for connecting the air guide channel (21) with the fan (15) and at least one blow-out opening (23) arranged sidewise of the tool opening (26).

2. A hand-held power tool according to claim 1, wherein the air guide channel (21) has a further blow-out opening (23) located opposite the at least one blow-out opening (23) and located on a side of the tool opening (26) opposite a side on which the at least one opening (23) is located.

3. A hand-held power tool according to claim 1, wherein the at least one opening (23) is formed as an elongate slot-shaped opening.

4. A hand-held power tool according to claim 1, wherein the air guide channel (21) is formed in the guide shoe (20).

5. A hand-held power tool according to claim 1, wherein the protective cover device (30) has at least one tubular connection union (23) that projects from the cover member (31) for connection with a suction device.

6. A hand-held power tool according to claim 5, wherein the at least one tubular connection union (21) is located diametrically opposite the at least one blow-out opening (23).
